(19) United States
(12) Patent Application Publication
(10) Pub. No.: US 2024/0151201 A1
(43) Pub. Date: May 9, 2024

(54) VEHICLE EMERGENCY STARTING DEVICE AND A CONTROL METHOD THEREOF

(71) Applicant: DH ENERGY SYSTEM CORPORATION, Seoul (KR)

(72) Inventor: Dong-Hwi Kim, Uijeongbu-si (KR)

(21) Appl. No.: 18/091,836

(22) Filed: Dec. 30, 2022

(30) Foreign Application Priority Data
Nov. 5, 2022 (KR) 10-2022-0146614

(51) Int. Cl. F02N 11/08

(52) U.S. Cl. CPC F02N 11/0866; F02N 11/087; F02N 2011/0885

(57) ABSTRACT

The vehicle emergency starting device includes a first switch, a capacitor module, a second switch, a booster, and a third switch. The first switch connects the battery group to the starter motor of the vehicle, the capacitor module is connected in parallel with the battery group, the second switch connects the capacitor module to the starter motor, and the booster uses power provided by the battery group to boost the capacitor module, and the third switch connects the battery group and the capacitor module through the booster. According to this configuration, the booster boosts the voltage of the battery group to supply to the capacitor module, the capacitor module can be charged even when the voltage of the battery group is lower than the voltage of the capacitor module, and the voltage for starting the vehicle can be supplied even when both the battery group and the capacitor module are discharged.

### CROSS-REFERENCE TO RELATED APPLICATION

This application is based on and claims priority to Korean Patent Application No. 10-2022-0146614 filed on Nov. 5, 2022, with the Korean Intellectual Property Office, the disclosure of which is incorporated herein by reference in its entirety.

### TECHNICAL FIELD

The present invention relates to a vehicle emergency starting device and a control method thereof, and more particularly, to a vehicle emergency starting device and a control method thereof that is used in place of or in addition to a vehicle battery to allow the vehicle to be started even when the battery is discharged.

### BACKGROUND

Conventional methods available when a vehicle battery is discharged may include starting the vehicle through a battery of another vehicle using a jump wire, charging the vehicle battery using a dedicated battery charger, etc. However, these methods are not useful when no other vehicles or dedicated battery chargers exist.

As a prior art for solving this problem, Korean Patent No. 10-1571110, registered on Nov. 17, 2015, discloses a technology of receiving current from a discharged vehicle battery to charge a high-capacitance storage device (e.g., supercapacitor, ultracapacitor, electric double layer capacitor, etc.) and providing current to the discharged vehicle battery through high-output discharge of the high capacitance storage device.

However, in the prior art, when the voltage of the vehicle battery is lower than the voltage of the high-capacitance storage device, as in the case where the battery installed in the vehicle is discharged in a state in which the engine cannot be started, the high-capacitance storage device cannot be charged. In addition, there is a problem in that no action can be taken when both the vehicle battery and the high-capacitance storage device are discharged simultaneously.

### DISCLOSURE OF INVENTION

### Problems to be Solved by the Invention

The present invention has been made to solve the above-mentioned problems, and an object of the present invention is to provide a device capable of supplying a voltage for starting a vehicle even when a vehicle battery is discharged and a control method thereof.

Another object of the present invention is to provide a device embedding a primary battery module for replacing a battery of a vehicle, capable of supplying a voltage for starting a vehicle even when the primary battery module is discharged, and a control method thereof.

Another object of the present invention is to provide a device capable of supplying a voltage for starting a vehicle even when both a battery group and a capacitor module are discharged, and a control method thereof.

Another object of the present invention is to provide a device capable of supplying a voltage for starting an eco-friendly vehicle even when both a low-power battery module and a capacitor module are discharged, and a control method thereof.

Also, another object of the present invention is to provide a vehicle emergency starting device and method applicable to eco-friendly vehicles such as electric vehicles, hybrid vehicles, and hydrogen fuel cell vehicles.

In addition, the present invention is to provide a vehicle emergency starting device and a control method thereof optimized for a given vehicle through learning using artificial intelligence using big data on internal variables such as capacity, type, and state of batteries and capacitors and external variables such as ambient temperature and humidity.

In addition, the present invention is to provide a vehicle emergency starting device and a control method thereof that analyzes the starting power according to the state of the discharged battery and the ambient temperature to boost the voltage of the discharged battery by stepping up and down the electrical current.

### Means for Solving the Problem

To achieve the above object, a vehicle emergency starting device according to an embodiment of the present invention includes a battery group connectable to a starter motor of a vehicle through a first switch; a capacitor module connectable to the starter motor in parallel with the battery group through a second switch; a booster connected between the battery group and the capacitor module through a third switch; and a control unit for controlling operations of the switches and the booster, wherein the control unit controls the booster to boost power supplied from the battery group and charge the capacitor module.

In addition, the control unit controls to close the first and second switches and open the third switch at a normal state.

In addition, the control unit determines whether the vehicle can be started by the battery group or the capacitor module and controls to close the third switch when it is determined that the vehicle cannot be started.

In addition, when the third switch is closed, the control unit controls to open one of the first and second switches.

In addition, when the third switch is closed, the control unit controls to open both the first and second switches.

In addition, the control unit determines whether or not the vehicle can be started by the battery group or the capacitor module, and controls the second switch to be closed when it is determined that the vehicle can be started.

In addition, the control unit controls to open the third switch when the second switch is closed.

In addition, the control unit stops the connection of the third switch when the number of connections of the third switch exceeds a predetermined reference number of times.

In addition, the control unit determines whether the vehicle can be started using terminal voltages of the battery group and the capacitor module connected in parallel with each other and the internal resistance of the battery group.

In addition, the battery group is composed of a connection between an external battery installed in the vehicle and an internal battery module embedded in the vehicle emergency starting device.

In addition, at least the first switch among the above switches is composed of one of the FET switches, a b-contact relay, and a latching relay.

On the other hand, to achieve the above object, a vehicle emergency starting device according to another embodiment of the present invention includes a battery module connectable to a starter motor of a vehicle; a capacitor module connectable to the starter motor in parallel with the battery module through a first switch; a booster connected between the battery module and the capacitor module through a second switch; and a control unit for controlling operations of the above switches and the booster, wherein the control unit controls the booster to boost power supplied from the battery module and charge the capacitor module.

In addition, the control unit normally closes the first switch and opens the second switch.

In addition, the control unit determines whether or not the vehicle can be started by the battery module or the capacitor module, and controls the second switch to be closed when it is determined that the vehicle cannot be started.

In addition, the control unit controls to open the first switch when the second switch is closed.

In addition, when the second switch is closed, the control unit controls the first switch to be closed.

In addition, the control unit determines whether the vehicle can be started by the battery module or the capacitor module, and controls the first switch to be closed when it is determined that the vehicle can be started.

In addition, the control unit controls to open the second switch when the first switch is closed.

In addition, the control unit controls to discontinue the connection of the second switch when the number of connections of the second switch is equal to or greater than a predetermined reference number of times.

In addition, the control unit determines whether the vehicle can be started by using terminal voltages of the battery module and the capacitor module connected in parallel with each other and the internal resistance of the battery module.

In addition, the battery module is configured to be connected to an external battery installed in the vehicle.

Meanwhile, to achieve the above object, a vehicle emergency starting device according to another embodiment of the present invention includes a primary battery group connectable to a starter motor of a vehicle through a first switch; a secondary battery module connectable to the starter motor in parallel with the battery group through a second switch; a booster connected between the primary battery group and the secondary battery module through a third switch; and a control unit for controlling operations of the above switches and the booster, wherein the control unit controls the booster to boost power supplied from the primary battery group and charge the secondary battery module.

In addition, the control unit controls the first and second switches to be closed and the third switch to be opened at normal state.

In addition, the control unit determines whether the vehicle can be started by the primary battery group or the secondary battery module, and controls to close the third switch when it is determined that the vehicle cannot be started.

In addition, when the third switch is closed, the control unit controls to open one of the first and second switches.

In addition, when the third switch is closed, the control unit controls to open both the first and second switches.

In addition, the control unit determines whether or not the vehicle can be started by the primary battery group or the secondary battery module, and controls the second switch to be closed when it is determined that the vehicle can be started.

In addition, the control unit controls to open the third switch when the second switch is closed.

In addition, the control unit controls to discontinue the connection of the third switch when the number of connections of the third switch is equal to or greater than a predetermined reference number of times.

In addition, the control unit determines whether the vehicle can be started using terminal voltages of the primary battery group and the secondary battery module connected in parallel, and the internal resistance of the primary battery group.

In addition, the primary battery group is configured by connecting an external battery installed in the vehicle and an internal battery module embedded in the vehicle emergency starting device.

On the other hand, to achieve the above object, an eco-friendly vehicle emergency starting device according to another embodiment of the present invention includes a primary battery module connectable to an electric load of a vehicle through a first switch; a capacitor module connectable to the electrical load in parallel with the primary battery module through a second switch; a booster connected between the primary battery module and the capacitor module through a third switch; and a control unit for controlling operations of the above switches and the booster, wherein the control unit boosts the power supplied from the primary battery module and charge the capacitor module.

In addition, the control unit controls the first and second switches to be closed and the third switch to be opened at normal state.

In addition, the control unit determines whether the vehicle can be started by the primary battery module or the capacitor module, and controls the third switch to be closed when it is determined that the vehicle cannot be started.

In addition, when the third switch is closed, the control unit controls to open one of the first and second switches.

In addition, when the third switch is closed, the control unit controls to open both the first and second switches.

In addition, the control unit determines whether the vehicle can be started by the primary battery module or the capacitor module, and controls the second switch to be closed when it is determined that the vehicle can be started.

In addition, the control unit controls to open the third switch when the second switch is closed.

In addition, the control unit stops the connection of the third switch when the number of connections of the third switch exceeds a predetermined reference number of times.

In addition, the control unit determines whether the vehicle can be started using terminal voltages of the primary battery module and the capacitor module connected in parallel with each other and the internal resistance of the primary battery module.

In addition, the primary battery module is connected in series or parallel with an external battery installed in the vehicle.

On the other hand, to achieve the above object, a vehicle emergency starting device using artificial intelligence and big data according to another embodiment of the present invention includes a primary battery module connectable to a starter motor of a vehicle through a first switch; a capacitor module or secondary battery module connectable to the starter motor in parallel with the battery group through a second switch; a booster connected between the primary battery module and the capacitor module or the secondary battery module through a third switch; a control unit for controlling operations of the above switches and the booster; a Big data DB for storing big data related to vehicle startup; and an artificial intelligence (AI) module that selects an optimal emergency charging algorithm through learning using the big data, wherein the control unit boosts power supplied from the primary battery module to charge the capacitor module or the secondary battery module.

In addition, the control unit controls the booster according to the optimal emergency charging algorithm selected by the artificial intelligence module, and the capacitor module or the secondary battery module has relatively better output performance than the primary battery module.

In addition, the control unit normally closes the first switch and the second switch and opens the third switch, and determines whether the vehicle can be started by the primary battery group or the secondary battery module, when it is determined that starting is impossible, the third switch is controlled to be closed.

In addition, when the third switch is closed, the control unit controls to open at least one of the first switch and the second switch, and determines whether the vehicle can be started by the primary battery group or the secondary battery module, when it is determined that starting is possible, the second switch is controlled to be closed.

In addition, the control unit controls to discontinue the connection of the third switch when the number of connections of the third switch is equal to or greater than a predetermined reference number of times.

In addition, the emergency starting device includes a short-distance communication module for communicating with a user terminal; and a remote communication module for performing long-distance communication with the remote server.

In addition, the control unit performs data communication with the remote server using a long-distance communication module in a normal state, and performs communication with the user terminal using a short-distance communication module when a vehicle is started in an emergency.

In addition, the long-distance communication module is an LTE communication module, and the short-distance communication module is a Bluetooth communication module.

In addition, in normal times, the vehicle emergency starting device operates by receiving a user's control command through LTE communication between the vehicle emergency starting device, the remote server, and the user terminal, and when the vehicle is emergency started, the vehicle emergency starting device connects directly to the user terminal to operate by receiving user control commands through Bluetooth communication.

In addition, the primary battery module of the emergency starting device is a low-voltage battery normally installed in a vehicle.

In addition, in order to achieve the above object, a vehicle emergency starting device according to another embodiment of the present invention includes a battery group connectable to a starter motor of a vehicle through a first switch; a capacitor module connectable to the starter motor in parallel with the battery group through a second switch; a booster connected between the battery group and the capacitor module through a third switch; and a control unit for controlling operations of the above switches and the booster, wherein the control unit controls the booster to boost power supplied from the battery group and charge the capacitor module, wherein the control unit measures the battery group within a predetermined period of time to determine whether voltage boosting is possible, and wherein the control unit increases the current step by step if it is determined that voltage boosting is possible and decreases the current step by step if it is determined that voltage stepping is impossible.

In addition, the control unit controls the first and second switches to be closed and the third switch to be opened at normal state.

In addition, the control unit determines whether the vehicle can be started by the battery group or the capacitor module, and controls to close the third switch when it is determined that the vehicle cannot be started.

In addition, when the third switch is closed, the control unit controls to open one of the first and second switches.

In addition, when the third switch is closed, the control unit controls to open both the first and second switches.

In addition, the control unit determines whether or not the vehicle can be started by the battery group or the capacitor module, and controls the second switch to be closed when it is determined that the vehicle can be started.

In addition, the control unit controls to open the third switch when the second switch is closed.

In addition, the control unit controls to discontinue the connection of the third switch when the number of connections of the third switch is equal to or greater than a predetermined reference number of times.

In addition, the control unit determines whether the vehicle can be started using terminal voltages of the battery group and the capacitor module connected in parallel with each other and the internal resistance of the battery group.

In addition, the battery group is composed of a connection between an external battery installed in the vehicle and an internal battery module embedded in the vehicle emergency starting device.

### Effect of the Invention

According to the present invention, the booster boosts the voltage of the primary battery module, such as a vehicle battery or an embedded battery, and supplies it to components having high power density and high energy density, such as a capacitor module or a secondary battery module, it is possible to supply voltage for starting a vehicle even when both the battery module and the capacitor module are discharged simultaneously.

In addition, when starting a vehicle, the power flow from the capacitor or secondary battery module to the discharged battery or the dark current of the vehicle is blocked by a control unit, thereby reducing the loss of secured starting power.

In addition, by using switching elements such as FET switches, b-contact relays, and latching relays, it is possible to minimize power consumption during voltage boosting, waiting for starting after boosting the voltage, and vehicle driving, and minimize emergency charging or boosting time.

In addition, by determining the charging current according to the detected temperature, it is possible to use the emergency starting device stably even at low temperatures by limiting charging at low temperatures and reducing the risk of battery modules composed of lithium-based batteries.

In addition, even when starting power is secured, it is possible to prepare for the final discharge situation by considering re-discharge due to long-term neglect and the limit of residual energy.

In addition, since the vehicle emergency starting device can be configured to replace the vehicle's existing battery, a separate battery installed in the vehicle is not required.

In addition, the vehicle emergency starting device can be configured with only the regenerative starting system added to the vehicle's primary battery so that the existing vehicle battery can be utilized as it is.

In addition, the vehicle starting device may be configured using an energy storage system (ESS) of degraded quality as a primary battery module.

In addition, since it is possible to start a vehicle using a discharged battery, the life of the battery can be greatly extended.

In addition, as the terminal voltage is measured by connecting the primary battery module and the capacitor or the secondary battery module in parallel, the energy and output can be accurately determined, and the determination of discharge can be made more clearly.

In addition, the present invention can be applied to eco-friendly vehicles such as electric vehicles, hybrid vehicles, and hydrogen fuel cell vehicles.

In addition, the present invention provides a device and method optimized for a given vehicle through learning using artificial intelligence using big data on internal variables such as capacity, type, and state of batteries and capacitors and external variables such as ambient temperature and humidity.

In addition, according to the present invention, it is possible to determine an optimal charging voltage within a short time while minimizing power consumption through stepwise current increase and decrease during an emergency startup.

In addition, it is possible to provide an optimal process for starting the vehicle in a manner in which the current is increased or decreased step by step by analyzing the starting power according to the state of the discharged battery and the ambient temperature.

### BRIEF DESCRIPTION OF DRAWINGS

FIG. 1 is a schematic block diagram of a vehicle emergency starting device according to the first embodiment of the present invention.

FIG. 2 is a circuit diagram according to one aspect of the vehicle emergency starting device according to the first embodiment of the present invention.

FIG. 3 is a circuit diagram according to another aspect of the vehicle emergency starting device according to the first embodiment of the present invention.

FIG. 4 is a circuit diagram according to yet another aspect of the vehicle emergency starting device according to the first embodiment of the present invention.

FIG. 5 is a circuit diagram according to one aspect of a vehicle emergency starting device according to a second embodiment of the present invention.

FIG. 6 is a circuit diagram according to another aspect of the vehicle emergency starting device according to the second embodiment of the present invention.

FIG. 7 is a circuit diagram according to yet another aspect of the vehicle emergency starting device according to the second embodiment of the present invention.

FIG. 8 is a circuit diagram according to still another aspect of the vehicle emergency starting device according to the second embodiment of the present invention.

FIG. 9 is a flowchart of a passive process of the vehicle emergency starting device according to the first and second embodiments of the present invention.

FIG. 10 is a flowchart of an active process of a vehicle emergency starting device according to the first and second embodiments of the present invention.

FIG. 11 is a table summarizing the functions of switches in the vehicle emergency starting device according to the first and second embodiments of the present invention.

FIG. 12 is a schematic block diagram of a vehicle emergency starting device according to a third embodiment of the present invention.

FIG. 13 is a circuit diagram according to an aspect of the vehicle emergency starting device according to the third embodiment of the present invention.

FIG. 14 is a flow chart of a passive process of a vehicle emergency starting device according to a third embodiment of the present invention.

FIG. 15 is a flowchart of an active process of a vehicle emergency starting device according to a third embodiment of the present invention.

FIG. 16 is a table summarizing the functions of switches in the vehicle emergency starting device according to the third embodiment of the present invention.

FIG. 17 shows the relationship between SOC and terminal voltage when a battery module is used alone.

FIG. 18 shows the relationship between SOC and terminal voltage when a capacitor module is used alone.

FIG. 19 shows the relationship between SOC and terminal voltage when a combination of a battery module and a capacitor module is used.

FIG. 20 is an equivalent circuit diagram of a starting system for an internal combustion engine.

FIG. 21 is a conceptual diagram of a vehicle emergency starting system using artificial intelligence and big data applied to a vehicle with an internal combustion engine, according to an embodiment of the present invention.

FIG. 22 is a conceptual diagram of a vehicle emergency starting system using artificial intelligence and big data applied to an eco-friendly vehicle, according to an embodiment of the present invention.

FIG. 23 is a flowchart of an active process of a vehicle emergency starting system using artificial intelligence according to an embodiment of the present invention.

FIG. 24 is a flow chart of a stepwise current increase/decrease process in a vehicle emergency starting device according to an embodiment of the present invention.

### DESCRIPTION OF THE INVENTION

Hereinafter, some embodiments of the present invention will be described with reference to the accompanying drawings.

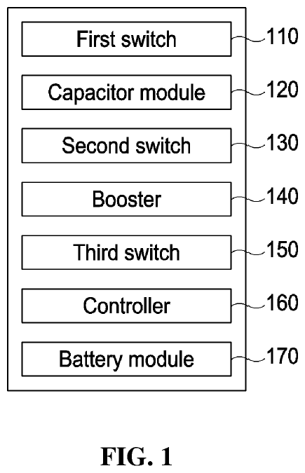

FIG. 1 is a block diagram of a vehicle emergency starting device according to the first embodiment of the present invention.

In FIG. 1, the vehicle emergency starting device of the present invention basically includes a first switch 110, a capacitor module 120, a second switch 130, a booster 140, a third switch 150, a control unit 160, and a battery module 170.

Here, the first switch (S1) 110, the second switch (S2) 130, and/or the third switch (S3) 150 may be implemented by FET switches, b contact relays, or latching relays to minimize power consumption during circuit operation. Since the first switch 110 is a part of a high-current circuit through which a current of several tens of amperes (A) or more flows, it is more important to select a switch type to minimize power consumption.

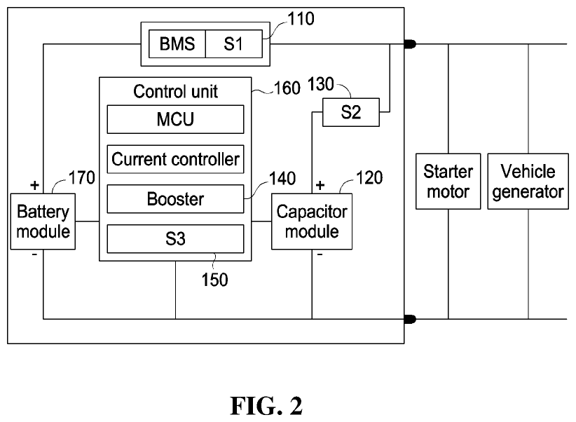

FIG. 2 is a circuit diagram according to an aspect of the vehicle emergency starting device according to the first embodiment of the present invention.

The vehicle emergency starting device shown in FIG. 2 includes an embedded battery module 170, and thus a conventional battery installed in a vehicle is unnecessary. The vehicle emergency starting device of FIG. 2 preferably has an external configuration so that it can be mounted at the same location instead of a conventional battery installed in a vehicle. In general, since there are two terminals in a vehicle's battery, the emergency starting device of FIG. 2 also has two external terminals to replace the existing vehicle battery.

In FIG. 2, the battery module 170 and the capacitor module 120 are connected in parallel to the vehicle's starter motor. The battery module 170, being connected in series with the first switch 110, is connected to the starter motor of the vehicle (here, the battery module 170 may be implemented to be included in a battery management system (BMS)). The capacitor module 120, connected in series with the second switch 130, is connected to the vehicle's starter motor. The battery module may be composed of a lead-acid battery or a lithium ion-based battery, and the capacitor module may be composed of a combination of a plurality of capacitor units.

In FIG. 2, the first switch 110 is connected between the positive electrode of the battery module 170 and the non-grounded terminal of the starter motor, and the second switch 130 is connected between the positive electrode of the capacitor module 120 and the non-grounded terminal of the starter motor.

In FIG. 2, a booster 140 (or a boost converter) is connected between the battery module 170 and the capacitor module 120. The booster 140 boosts the voltage of current (or the power) supplied from the battery module 170 to the capacitor module 120 by the third switch 150. When the third switch 150 is turned on, a closed circuit for voltage boosting is formed between the battery module 170 and the capacitor module 120.

According to this configuration, since the booster 140 boosts the voltage of the battery module 170 to supply the boosted voltage to the capacitor module 120, the capacitor module 120 can be charged even when the voltage of the battery module 170 is lower than the voltage of the capacitor module 120. The voltage required for starting the vehicle can be supplied through boosting process even when both the battery module 170 and the capacitor module 120 are discharged.

The capacitor module 120 has a lower charging capacity than the battery module 170 but has a higher output due to a shorter charging and discharging time. The capacitor module 120 can be boosted even when the battery module 170 cannot start the engine. After charging, the starter motor can be driven using the charged capacitor module 120.

The control unit 160 determines whether the vehicle can be started, and when it is determined that the vehicle cannot be started, the control unit 160 connects the third switch 150 to form a booster circuit including the battery module 170, the third switch 150, and the capacitor module 120.

Meanwhile, the control unit 160 may determine whether the vehicle can be started by using the terminal voltage of the battery module 170 and the capacitor module 120 connected in parallel or the size of the internal resistance of the battery module 170. According to this configuration, it is possible to determine whether the vehicle can be started more accurately.

FIGS. 17 to 19 are graphs showing the relationship between a state of charge (SOC) (or remaining energy capacity) and a terminal voltage in the case of a battery module alone, a capacitor module alone, and a combination of a battery module and a capacitor module, respectively.

In the case of the battery module in FIG. 17, that is, a battery module composed of a lead-acid battery such as a vehicle battery, it is difficult to determine the SOC through terminal voltage measurement because the terminal voltage does not decrease proportionally when the SOC is lowered. In other words, since the battery module provides a high terminal voltage even when the energy is depleted, it is difficult to determine whether the vehicle can be started through voltage monitoring.

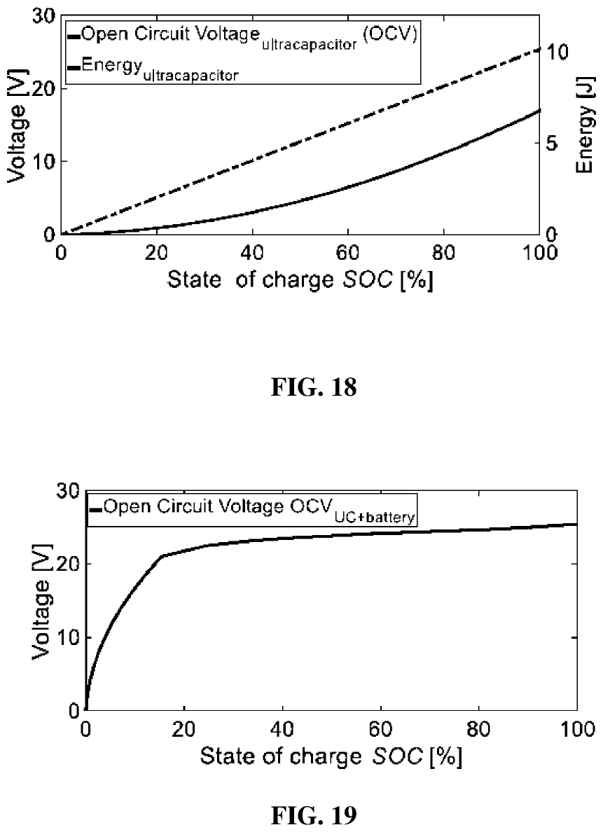

In the case of the capacitor module in FIG. 18, since the terminal voltage decreases as the SOC decreases, it is possible to determine the SOC easily and whether the vehicle can be started based on the SOC through the measurement of the terminal voltage.

In the case of a combination of a battery module and a capacitor module in FIG. 19, the terminal voltage rapidly decreases when the SOC decreases below a predetermined value (e.g., 20%). Using these characteristics, it is possible to determine the SOC accurately and whether the vehicle can be started.

When the battery discharge has progressed significantly, it is inaccurate to determine the battery output using its terminal voltage. However, according to the method of the present invention for measuring the terminal voltage by connecting the battery module and the capacitor module in parallel, it is possible to determine the remaining energy and output of the parallel connected system more accurately.

Returning to FIG. 2, the control unit 160 of FIG. 2 normally closes the first and second switches 110 and 130 to connect the battery module 170 and the capacitor module 120 at the same time (i.e., S1 close, S2 close, S3 open), through which it is determined whether the vehicle can be started based on the decrease in terminal voltage. When it is determined that starting is impossible, the third switch 150 is connected (i.e., S3 close) to drive a booster circuit composed of the battery module 170, the third switch 150, and the capacitor module 120.

In FIG. 2, control unit 160 includes an MCU that monitors and controls the voltage, current, temperature, etc. It includes a booster having a third switch to boost voltage between the battery module 170 and the capacitor module 120. It also includes sensors for detecting the voltage, current, and ambient temperature of the battery module and the capacitor module. It includes a current controller to limit the charging current from the vehicle generator to the battery module 170. In some cases, it may be configured to include some or all of the control actions of the battery management system (BMS) of the battery module 170.

On the other hand, when battery module 170, composed of a lithium-based battery other than a conventional lead-acid battery, is charged at a temperature below zero, the internal resistance increases due to plating and dendrite growth. In serious cases, an internal short-circuit situation may occur. Therefore, as shown in FIG. 2, when the charging current is determined according to the temperature detected by the control unit having an MCU and a sensor for detecting the temperature, it is possible to reduce the risk of the battery module 170 composed of a lithium-based battery by operating it in the low-temperature operation mode at a temperature below zero. It is also possible to reduce the risk by charging the battery module 170 only at room temperature. In a low-temperature operation mode, the battery module 170 is charged with a low current or may be prevented from charging.

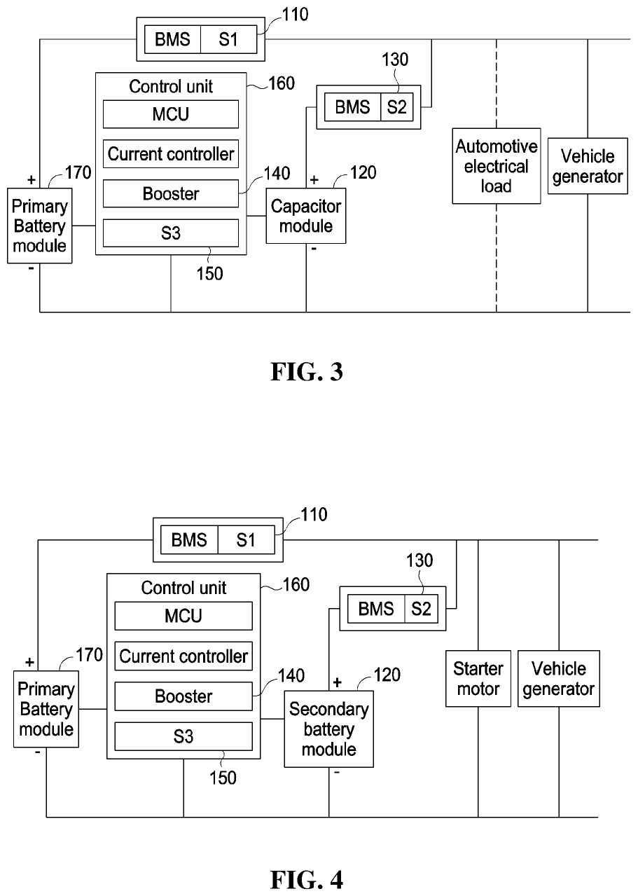

FIG. 3 is a circuit diagram according to another aspect of the vehicle emergency starting device according to the first embodiment of the present invention.

FIG. 3 shows a case in which the emergency starting device is applied to an eco-friendly or low-emission vehicle, such as an electric vehicle, a hybrid vehicle, or a fuel cell vehicle.

An electric vehicle is a battery electric vehicle (BEV). Hybrid Electric Vehicles (HEV) and Plug-in Hybrid Electric Vehicle (Plug-in HEV) are collectively called hybrid vehicles. Among fuel cell vehicles, there is a fuel cell electric vehicle (FCEV). Research on various types of eco-friendly vehicles is still underway.

Eco-friendly vehicles commonly include a structure in which electricity from a high-voltage battery is applied to a driving motor to drive the vehicle, and separately from the high-voltage battery, a conventional vehicle battery, that is, a low-voltage battery is provided to apply power to low-voltage parts such as electric components. A hybrid vehicle additionally has a fuel tank and an engine in addition to basic components such as a high-voltage battery and a drive motor, and a fuel cell vehicle has a hydrogen tank and an auxiliary battery in addition to a drive motor and fuel cell (here, the fuel cell corresponds to a high-voltage battery).

Electric vehicles, which are representative eco-friendly vehicles, supply power to high-power/high-voltage battery (e.g., lithium-ion battery, LIB) through a charger (i.e., On-Board Charger, OBC) that converts external AC power into DC power, and the high-power/high-voltage battery provide driving power to the vehicle.

The Electric Power Control Unit (EPCU) is a power conversion system that includes a Vehicle Control Unit (VCU), Low-voltage DC-DC Converter (LDC), High-voltage DC-DC Converter (HDC), and Inverter. The VCU performs vehicle control such as vehicle drive motor control, regenerative braking control, air conditioning load control, electric load power supply control, cluster display, signal processing, and vehicle diagnosis. LDC converts direct current from the high-power/high-voltage battery into low-voltage direct current to supply to vehicle electric load and 12V low-voltage batteries. HDC boosts DC power and supplies it to the Motor Control Unit (MCU) (including the Inverter) to increase the output and efficiency of the driving motor. The Inverter converts DC from a high-power/high-voltage battery into AC to supply to the driving motor. The Power Relay Assembly (PRA) blocks or connects the driving power or supports the fast-charging function.

Eco-friendly vehicles usually use a low-voltage battery to apply power to the high-voltage battery's battery management system (BMS). Discharge of the low-voltage battery causes problems in the operation of the high-voltage battery, thereby causing eco-friendly vehicles to be unable to start.

In FIG. 3, the vehicle emergency starting device of the present invention includes a primary battery module 170, which is a low-voltage battery replacing a conventional 12V lead-acid battery, a capacitor module 120, a booster 140, a first switch 110, a second switch 130, a third switch 150, and a control unit 160. To minimize power consumption during circuit operation, the first, second, and third switches may be configured as FET switches, b contact relays, or latching relays.

The vehicle's electric load in FIG. 3 means a vehicle's electric load connected to a low-voltage battery and driven by a low voltage, and the vehicle emergency starting device of the present invention is charged through the LDC of the vehicle. Since the vehicle emergency starting device shown in FIG. 3 includes the primary battery module 170, a conventional low-voltage battery in the form of a lead-acid battery installed in a vehicle is unnecessary. Therefore, it is preferable that the vehicle emergency starting device of FIG. 3 also has an external configuration so that it can be mounted at the same location instead of the conventional battery installed in the vehicle. In general, there are two connecting terminals in the low-voltage battery in a vehicle, the emergency starting device of FIG. 3 is configured to have two external connecting terminals to replace the existing low-voltage battery in a vehicle.

In FIG. 3, the primary battery module 170 and the capacitor module 120 are connected to provide power to the automotive electric load (including the BMS of the high-voltage battery). In FIG. 3, the first switch 110 is positioned between the positive electrode of the primary battery module 170 and the vehicle electric load, and the second switch 130 is positioned between the positive electrode of the capacitor module 120 and the vehicle electric load.

In FIG. 3, the booster 140 is connected between the primary battery module 170 and the capacitor module 120 and boosts the current from the primary battery module 170 by the third switch 150 to supply to the capacitor module 120. When the third switch 150 is closed, a closed circuit for voltage boosting is formed between the primary battery module 170 and the capacitor module 120.

According to this configuration, the booster 140 boosts the voltage of the primary battery module 170 to supply to the capacitor module 120, the capacitor module 120 can be charged even when the voltage of the primary battery module 170 is lower than the voltage of the capacitor module 120. Even when both the primary battery module 170 and the capacitor module 120 are discharged to such a level that the low-voltage electric system cannot be activated, it is possible to supply the necessary power to the vehicle's electric system or electric load through voltage-boosting, and thus the high-power/high-voltage battery can operate to provide driving power to the vehicle.

The capacitor module 120 has a lower charging capacity than the primary battery module 170 but has a high output due to a short charging and discharging time, and thus it is possible to charge the capacitor module by boosting even when the vehicle cannot be started with the basic battery module 170. After charging 120, the electric load can be driven using the capacitor module 120.

The control unit 160 determines whether power can be supplied to the vehicle's electric load (including whether the vehicle can be started) and if it is determined that starting is impossible, the third switch 150 is connected to drive the boosting circuit comprising the primary battery module 170, the third switch 150 and the capacitor module 120.

Meanwhile, control unit 160 may determine whether or not the vehicle can be started by using terminal voltages of the primary battery module 170 and the capacitor module 120 connected in parallel or the size of the internal resistance of the primary battery module 170. This configuration makes it possible to determine whether or not the vehicle can be started more accurately.

FIG. 4 shows a circuit diagram according to another aspect of the vehicle emergency starting device according to the first embodiment of the present invention.

In FIG. 4, there is a case where the secondary battery module 120 is used instead of a capacitor module. Here, the connection relationship and role of the secondary battery module 120 within the circuit are the same as that of the capacitor module.

The secondary battery module 120 has a lower charging capacity than the primary battery module 170 but has a better output performance, and thus it is possible to charge the secondary battery module 120 by boosting even when the vehicle cannot be started with the basic battery module 170. After charging, the starter motor can be driven using the secondary battery module 120. The secondary battery module 120 is a small-capacity battery that can be sufficiently charged with the residual energy of the primary battery module 170, and it should be able to generate a voltage sufficient to start the vehicle when it is fully charged or charged to a certain level or higher.

The secondary battery module should be composed of a secondary battery with output performance better than the primary battery module and capable of starting the engine by receiving residual energy even when the primary battery module is discharged. In addition to nickel-based batteries such as nickel-cadmium and nickel-hydrogen batteries, lithium-based batteries such as lithium-ion batteries, lithium-air batteries, lithium-sulfur batteries, and all-solid-state batteries, various types of next-generation batteries currently under development may be used as the secondary battery module. Suppose the output performance of the battery is better than that of the primary battery module and satisfies the conditions for starting the vehicle by receiving the residual energy of the primary battery module. In that case, it is qualified as a secondary battery module.

The control unit 160 determines whether the vehicle can be started, and if it is determined that the vehicle cannot be started, the control unit 160 connects the third switch 150 to drive a boost circuit composed of the primary battery module 170, the third switch 150 and the secondary battery module 120.

Meanwhile, control unit 160 determines whether the vehicle can be started by using the terminal voltages of the primary battery module 170 and the secondary battery module 120 connected in parallel or the size of the internal resistance of the primary battery module 170. In the case of the secondary battery module 120, the relationship between the state of charge (SOC) and the terminal voltage is not the same as that of the capacitor module. However, since there is an inflection point in the terminal voltage decrease as the SOC decreases, it is possible to easily check the SOC change and determine whether the vehicle can be started by measuring the terminal voltage. Eventually, when the primary battery module 170 and the secondary battery module 120 are combined, it is possible to more easily determine whether the vehicle can be started compared to the case of using the basic battery module 170 alone.

Meanwhile, suppose the battery, such as the secondary battery module 120, is a lithium-based battery charged at a temperature below zero. In that case, it causes an increase in internal resistance due to plating and dendrite growth, and in severe cases, it may result in a short-circuit situation. Therefore, when the charging current is determined according to the temperature detected by the control unit having an MCU and a sensor for detecting the temperature, it is possible to reduce the risk of the lithium-based batteries by operating in the low-temperature operation mode at a temperature below zero where the primary battery module 170 and/or the secondary battery module 120 are charged with a low current or prevented from charging. It is also possible to reduce the risk by charging battery modules 170 and 120 only at room temperature.

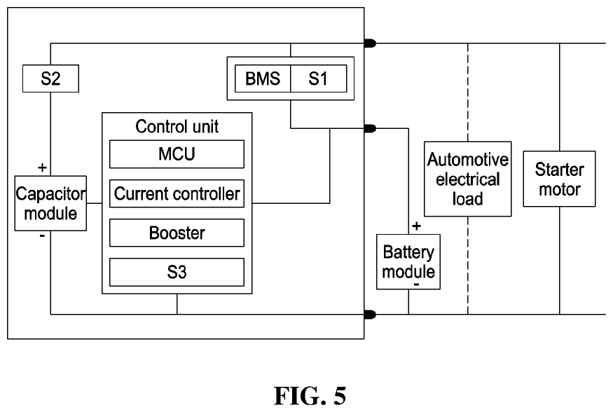

FIG. 5 shows a circuit diagram according to an aspect of a vehicle emergency starting device according to a second embodiment of the present invention.

According to the second embodiment of the present invention, the vehicle emergency starting device is configured to be used with an existing battery installed in a vehicle and has three connection terminals.

The vehicle emergency starting device in FIG. 5 is basically configured to be embedded with a first switch 110, a capacitor module 120, a second switch 130, a booster 140, a third switch 150, and a control unit 160. The battery installed in an existing vehicle is used as the battery module 170.

Even in this case, the first switch (S1) 110, the second switch (S2) 130, and/or the third switch (S3) 150 are preferably made by FET switches, b contact relays, or latching relays to minimize power consumption during circuit operation. In particular, since the first switch 110 is part of a high-current circuit through which a current of several tens of amperes (A) or more flows, it is more important to select a switch type for minimizing power consumption.

In FIG. 5, the battery module 170 is connected to the starter motor of the vehicle through the serially connected first switch 110 (here, the first switch 110 may be implemented to be included in a battery management system (BMS) for the battery module 170), and the capacitor module 120 is connected to the starter motor of the vehicle through the second switch 130 connected in series.

In FIG. 5, the first switch 110 is located between the positive electrode of the battery module 170 and the non-grounded terminal of the starter motor, and the second switch 130 is located between the positive electrode of the capacitor module 120 and the non-grounded terminal of the starter motor.

In FIG. 5, the booster 140 is connected between the battery module 170 and the capacitor module 120 and boosts the power supplied from the battery module 170 by the third switch 150 to supply to the capacitor module 120. When the third switch 150 is turned on, a closed circuit for voltage boosting is formed between the battery module 170 and the capacitor module 120.

According to this configuration, the booster 140 boosts the voltage of the battery module 170 to supply to the capacitor module 120, the capacitor module 120 can be charged even when the voltage of the battery module 170 is lower than the voltage of the capacitor module 120. Even when the battery module 170 and the capacitor module 120 are discharged, it is possible to supply the voltage for starting the vehicle through voltage boosting.

As described above, replacing the capacitor module with a secondary battery module made of secondary cells is also possible.

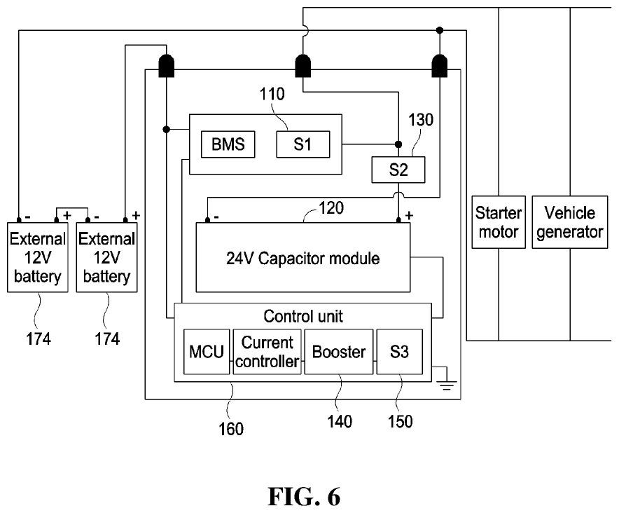

FIG. 6 is a circuit diagram showing another aspect of the vehicle emergency starting device according to a second embodiment of the present invention.

The vehicle emergency starting device of FIG. 6 does not include an internal battery module. Instead, the conventional external batteries 174, in which two 12V batteries are connected in series, are installed in the vehicle. Accordingly, the battery group subject to emergency charging in this device is the conventional external batteries 174 installed in the vehicle.

This configuration is suitable for large vehicles that require 24V power to start the vehicle, and the vehicle emergency starting device preferably has an external configuration so that it can be installed in the vehicle separately from the two external batteries (i.e., two 12V batteries connected in series) already installed in the vehicle.

In FIG. 6, the voltage of the capacitor module 120 should be capable of outputting the 24V voltage required for startup. The external battery group 174 and the capacitor module 120 are connected in parallel to the starter motor of the vehicle, the external battery group 174 is connected to the starter motor of the vehicle through the first switch 110 inside the device, and the capacitor module 120 is connected to the starter motor of the vehicle through the second switch 130 connected in series. The booster 140 in the control unit is connected in series between the battery group 174 and the capacitor module 120 to boost the voltage applied to the capacitor module 120 using power supplied from the battery group 174. The booster 140 connects the battery group 174 and the capacitor module 120 through the third switch 150.

According to this configuration, booster 140 boosts the residual voltage of battery group 174 to supply the boosted voltage to the capacitor module 120. The capacitor module 120 can be charged even when the voltage of battery group 174 is lower than the voltage of the capacitor module 120, and it is possible to supply the voltage required for starting the vehicle through voltage boosting even when all the battery group 174 and the capacitor module 120 discharged.

The MCU of the control unit 160 determines whether the vehicle emergency starting device can start the vehicle, and when it is determined that the vehicle cannot be started, the third switch 150 is connected to perform emergency charging. When the third switch 150 is connected or closed, the first switch 110 and the second switch 130 are opened, and when it is determined that the operation of the booster 140 can start the vehicle, the third switch 150 is disconnected or opened, and the second switch 130 is connected or closed again.

According to this configuration, when the control unit starts the vehicle, the power of the capacitor module 120 is blocked from flowing to the discharged battery group 174 or the dark current of the vehicle, thereby reducing the loss of the secured starting power.

Meanwhile, control unit 160 may determine whether the vehicle can be started by using the terminal voltage of the capacitor module 120 or the internal resistance of the battery group 174. This configuration makes it possible to determine whether or not the vehicle can be started more accurately.

In addition, control unit 160 may limit the charging current of the capacitor module 120 according to the temperature of the battery group 174. According to this configuration, by determining the amount of charging current according to the sensed temperature, charging may be limited at low temperatures, thereby reducing the risk of the lithium-based battery group 174, enabling the stable use of the battery device even at low temperatures.

The vehicle emergency starting device circuit of FIG. 6 includes a third connection terminal connected to one end of the external battery group 174 in addition to two external connection terminals connected to the starter motor. Therefore, it can be seen that the vehicle emergency starting device of FIG. 6 is in the form of a device used in addition to an external battery in the vehicle.

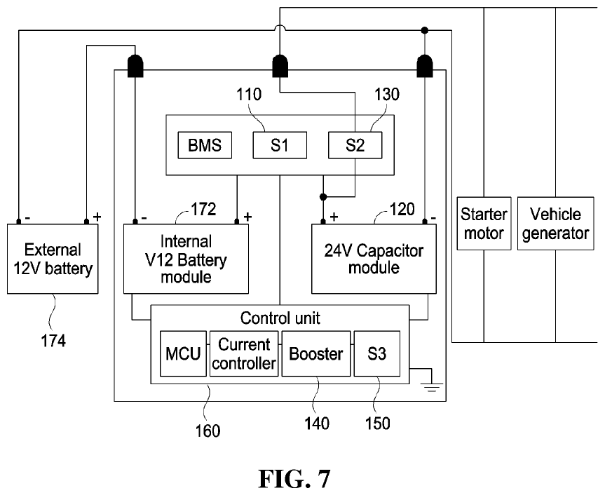

FIG. 7 is a circuit diagram for another aspect of the vehicle emergency starting device according to the second embodiment of the present invention.

The vehicle emergency starting device of FIG. 7 includes an internal battery module 172, and a separate battery or an external battery 174 is mounted in the vehicle. Accordingly, the battery groups subject to emergency charging in this device are the internal battery module 172 and the external battery 174 connected in series.

This configuration is needed in case 24V power is required to start a vehicle, such as a large vehicle, truck, or heavy equipment. The vehicle emergency staring device desirably has an external configuration so that it can be mounted to replace one of the two external batteries (i.e., two 12V external batteries connected in series) installed in the existing vehicle.

In FIG. 7, the voltage of the capacitor module 120 should be capable of outputting the 24V power required for startup. A 24V battery group in which the external battery 174 and the internal battery module 172 are connected in series (hereinafter referred to as ‘battery group’), and the capacitor module 120 are connected in parallel to the starter motor of the vehicle. The battery group is connected to the starter motor of the vehicle via the first switch 110 (here, it may be implemented by being included in the battery management system (BMS) for the internal battery module 172), and the capacitor module 120 is connected to the starter motor of the vehicle via the serially connected second switch 130. The booster 140 within the control unit is connected between the battery module 172 and the capacitor module 120 via the third switch 150. The booster 140 boosts and supplies the current from the battery group 172 and 174 to the capacitor module 120.

According to this configuration, booster 140 boosts the residual voltage of the battery groups 172 and 174 to supply to the capacitor module 120, the capacitor module 120 can be charged even when the voltage of the battery group 172 and 174 is lower than the voltage of the capacitor module 120, and the voltage for starting the vehicle can be supplied through boosting even when the battery groups 172 and 174 and the capacitor module 120 are all discharged.

The MCU of the control unit 160 determines whether the vehicle emergency starting device can start the vehicle, and when it is determined that the vehicle cannot be started, the third switch 150 is connected to perform emergency charging. When the third switch 150 is connected, the first switch 110 and the second switch 130 are opened, and when it is determined that the operation of the booster 140 can start the vehicle, the third switch 150 is turned open, and the second switch 130 is connected again.

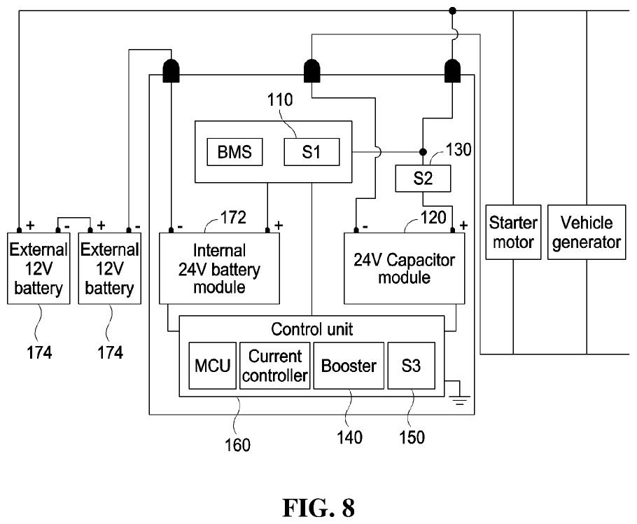

FIG. 8 is a circuit diagram according to another aspect of the vehicle emergency starting device according to the second embodiment of the present invention.

The vehicle emergency starting device of FIG. 8 includes an internal 24V battery module 172 and a separate battery, that is, external 24V batteries 174, in which two 12V batteries are connected in series mounted in the vehicle. Accordingly, this device's battery group subject to emergency charging is the parallel connected internal battery module 172 and the external battery 174.

This configuration is preferably applied when 24V power is required to start the vehicle, and the vehicle emergency starting device of FIG. 8 preferably has an external configuration so that it can be mounted on a vehicle in addition to the already mounted two external batteries (i.e., two 12V batteries connected in series).

In FIG. 8, the capacitor module 120 and the internal battery module 172 must be capable of outputting the 24V required for startup. The 24V battery group in which the external battery 174 and the internal battery module 172 are connected in parallel, and the capacitor module 120 are connected in parallel to the vehicle's starter motor. The internal battery module 172 of the battery group is connected to the first switch 110 (here, it can be implemented to be included in the battery management system (BMS) for the battery module 170) to be connected to the vehicle's starter motor. The capacitor module 120 is connected in series with the second switch 130 to be connected with the stater motor of the vehicle. The booster 140 in the control unit is connected in series between the battery module 172 and the capacitor module 120 to boost capacitor module 120 using the power supplied from battery group 172 and 174. The booster 140 connects the internal battery module 172 and the capacitor module 120 through the third switch 150.

According to this configuration, since the booster 140 boosts the residual voltage of the battery groups 172 and 174 to supply the boosted voltage to the capacitor module 120, the capacitor module 120 can be charged even when the voltage of the battery groups 172 and 174 is lower than the voltage of the capacitor module 120, and the voltage enough to start the vehicle can be supplied through boosting even when the battery groups 172 and 174 and the capacitor are discharged.

The MCU of the control unit 160 determines whether the vehicle emergency starting device can start the vehicle, and when it is determined that the vehicle cannot be started, the third switch 150 is connected to perform emergency charging. When the third switch 150 is connected, the first switch 110 and the second switch 130 are opened, and when it is determined that the operation of the booster 140 can start the vehicle, the third switch 150 is turned open, and the second switch 130 may be connected again.

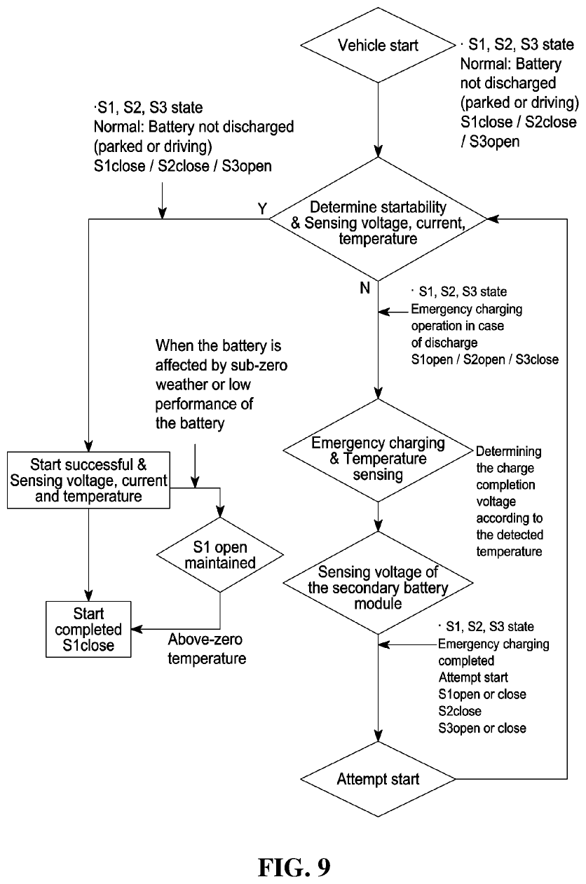

FIG. 9 is a flowchart of a passive process of the vehicle emergency starting device according to the first and second embodiments of the present invention.

The passive process will be described with reference to FIG. 9. The passive process is a process without the automatic charging process of the capacitor module 120 or the secondary battery module 120 in control unit 160.

First, the vehicle emergency starting device closes both the first switch 110 and the second switch 130 and opens the third switch 150, in a normal state of the vehicle where the battery is not discharged so that the battery module 170 and the capacitor module (or secondary battery module) 120 are all connected to the electrical load such as the starter motor of the vehicle. Then, the control unit 160 detects the voltage and temperature of the capacitor module (or secondary battery module) 120 and the battery module 170 to determine whether the vehicle is startable or emergency charging is necessary.

If it is determined that the vehicle can be started and then the start of the vehicle is completed, control unit 160 detects the voltage, current, temperature, etc. It opens the first switch 110 at temperatures below zero to limit the charging of the ion-based battery module 170 and closes the first switch 110 when the temperature is above zero to charge the battery module 170.

On the other hand, if it is determined that starting the vehicle is impossible, the control unit 160 opens the normally closed first switch 110 and the second switch 130 and closes the third switch 150 (i.e., S1 open, S2 open, S3 close). According to this configuration, loss of secured startup power can be reduced, and the startup of the vehicle can be done most quickly by blocking the flow of electric power from the capacitor module 120 to the discharged battery module 170 or to the dark current of the vehicle during emergency charging or emergency starting of the vehicle.

Alternatively, the control unit 160 may close the third switch 150 while keeping one of the first switch 110 or the second switch 130 closed (i.e., S1 open, S2 close, S3 close, or S1 close, S2 open, S3 close). According to this configuration, even when the voltage is boosted, one of the first switch 110 or the second switch 130 is closed so that a minimum amount of current flows to the vehicle, thereby preventing the vehicle's electrical components from resetting.

Subsequently, control unit 160 detects the voltage of the capacitor module 120 to determine whether the vehicle can be started or whether emergency charging should be completed. At this time, it is preferable to determine the charge completion voltage by sensing the temperature.

When the control unit 160 determines that the emergency charging is completed, it closes the second switch 130, and opens the third switch 150, to maintain a state where the vehicle can be started.

If the first switch 110 is closed, the discharged battery module 170 may be charged while the capacitor module 120 is in a charged state while waiting for the vehicle to start. If the first switch 110 is opened, the capacitor module 120 is maintained as charged, and it is possible to prepare for starting the vehicle without energy loss (i.e., S1 open/close, S2 close, S3 open).

In other words, if the second switch 130 is closed and the third switch 150 is opened after emergency charging, the vehicle stays in a standby state for starting with the charging completed. The passive process allows connection of the third switch 150 only when there is a user's input through a physical button or a dedicated software application.

In the passive process, the control unit 160 determines whether the vehicle can be started when there is user input and performs charging the capacitor module 120 when the vehicle cannot be started.

According to this configuration, a re-boost process can only be performed manually when re-discharge occurs due to long-term neglect after acquiring the starting power.

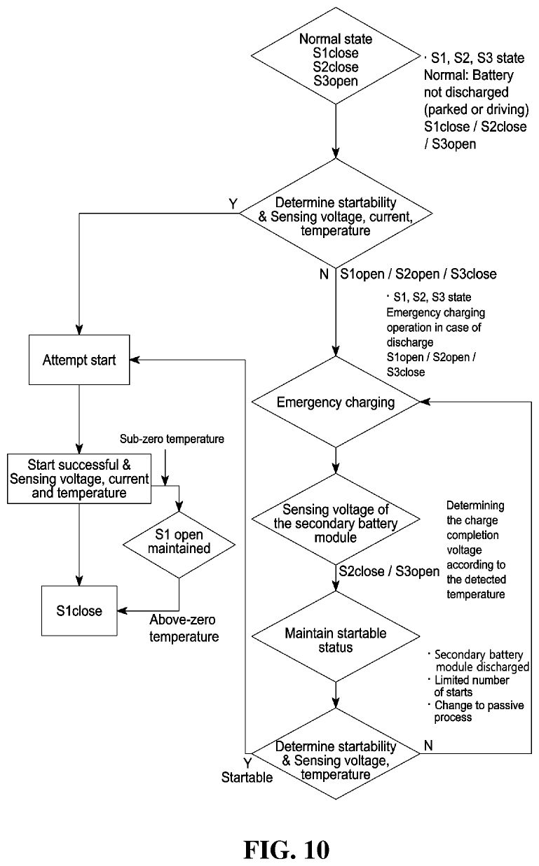

FIG. 10 is a flowchart of an active process of the vehicle emergency starting device according to the first and second embodiments of the present invention. The active process is a process that maintains the voltage of the capacitor module in a state where the vehicle can always be started.

First, the vehicle emergency starting device closes both the first switch 110 and the second switch 130 in a normal state and opens the third switch 150 to connect both the battery module 170 and the capacitor module 120 to the load, such as the starter motor of the vehicle (i.e., S1 close, S2 close, S3 open). At this time, control unit 160 detects the voltage and temperature of the capacitor 120 module and the battery module 170 to determine whether it is possible to start the vehicle or whether emergency charging is necessary.

If it is determined that the vehicle can be started and then the vehicle is started, the control unit 160 opens the first switch 110 to limit the charging of the ion-based battery module 110 at sub-zero temperatures and closes the first switch 110 to charge the battery module 110 at above-zero temperatures through detection of voltage, current, temperature, etc.

On the other hand, if it is determined that starting the vehicle is impossible, the control unit 160 opens the normally closed first switch 110 and the second switch 130 and closes the third switch 150 (i.e., S1 open, S2 open, S3 close). According to this configuration, loss of startup power is prohibited by blocking the flow of electric power of the capacitor module 120 to the discharged battery module 170 or the dark current of the vehicle during emergency charging through voltage boosting, and startup can be done most quickly.

Alternatively, the control unit 160 may close the third switch 150 while keeping one of the first switch 110 or the second switch 130 closed (i.e., S1 open, S2 close, S3 close, or S1 close, S2 open, S3 close). According to this configuration, even when the voltage is boosted, one of the first switch 110 and the second switch 130 is closed so that a minimum amount of current flows to the vehicle, thereby preventing the vehicle's electrical components from resetting.

Next, control unit 160 detects the voltage of the capacitor module 120 to determine whether the vehicle can be started or whether emergency charging is completed. At this time, it is preferable to determine the charge completion voltage by sensing the temperature.

When control unit 160 determines that the emergency charging is completed, it closes the second switch 130 and opens the third switch 150, to maintain a state where the vehicle can be started.

If the first switch 110 is closed, the discharged battery module 170 may be charged while the capacitor module 120 is in a charged state while waiting for the vehicle to start. If the first switch 110 is opened, then the capacitor module 120 is maintained in a charged state, and it is possible to prepare for starting of the vehicle without energy loss (i.e., S1 open/close, S2 close, S3 open).

Even while maintaining this state, control unit 160 detects the voltage and temperature of the capacitor module 120 to determine the startability of the vehicle. When it is determined that the start is impossible due to the discharge of the capacitor module 120, the control unit 160 closes the third switch 150, while the second switch 130 is closed, to charge the capacitor module 120 by another boost process (i.e., S1 open/close, S2 close, S3 close).

In other words, if the second switch 130 is closed and the third switch 150 is opened after emergency charging, the vehicle stays in a standby state for starting with the charging completed. However, if both the second switch 130 and the third switch 150 are closed, the capacitor module can be maintained in a fully charged state through a re-boosting process even though a voltage drop occurs in the capacitor module 120 while waiting for the startup of the vehicle.

Here, if the number of completed boost or re-boost processes is greater than or equal to a preset reference number or the voltage of the battery module 170 is less than a predetermined minimum value capable of starting the vehicle by boosting, the control unit 160 may limit the emergency charging process through the automatic connection of the third switch 150. When the automatic connection of the third switch 150 is interrupted in this way, it can be turned into a passive process where the third switch 150 can be re-connected only when there is a user's input.

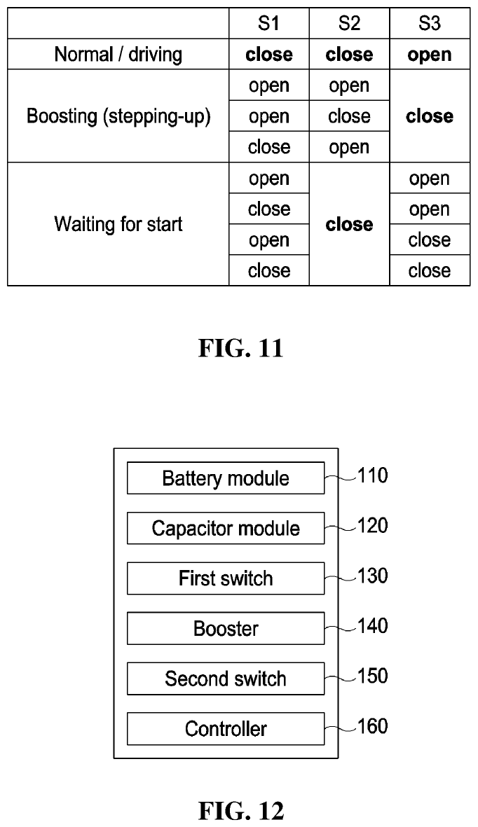

FIG. 11 is a table summarizing the functions of switches in the vehicle emergency starting device according to the first and second embodiments of the present invention. The first, second, and third switches are used in the first and second embodiments.

Basically, in a normal state (i.e., when the vehicle is parked, when the engine is started, or when the vehicle is driven), the first switch 110 and the second switch 130 are closed, and the third switch 150 is opened to maintain the battery module 170 and capacitor module 120 at an equal electric potential. In addition, during voltage boosting, the third switch 150 should be closed to drive the boost circuit, and after voltage boosting is completed, and vehicle starting is possible, the second switch 130 should be closed to prepare for starting through the capacitor module 120.

During boosting, you can limit current consumption due to a discharged battery by opening the first switch (S1), and you cam limit the current consumed by the dark current of the vehicle (or load) by opening the second switch (S2). Even after the vehicle is successfully started, the opening and closing of the first switch (S1) may be determined according to the sensed temperature.

FIG. 12 shows a block diagram of a vehicle emergency starting device according to a third embodiment of the present invention.

In FIG. 12, the vehicle emergency starting device of the third embodiment basically includes a battery module 110, a capacitor module 120, a first switch 130, a booster 140, a second switch 150, and a control unit 160.

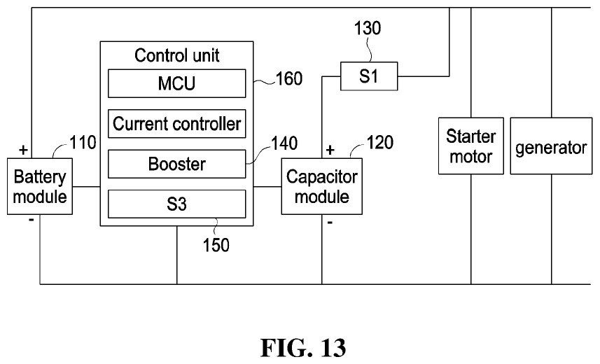

FIG. 13 is a circuit diagram according to one aspect of the vehicle emergency starting device according to the third embodiment of the present invention.

The vehicle emergency starting device shown in FIG. 13 includes the embedded battery module 110. Therefore, a conventional vehicle-mounted battery is unnecessary. The vehicle emergency starting device of FIG. 13 preferably has an external configuration so that it can be mounted at the same location instead of a conventional battery installed in a conventional vehicle. In general, since there are two connecting terminals in a vehicle's battery, the emergency starting device of FIG. 13 also has two external connecting terminals to replace the existing vehicle battery.

In FIG. 13, the battery module 110 and the capacitor module 120 are connected in parallel to the vehicle's starter motor. The battery module 110 may be implemented by including a battery management system (BMS). The battery module 110 is directly connected to the vehicle's starter motor, and the capacitor module 120 is connected to the starter motor of the vehicle through the first switch 130 connected in series. The battery module may be composed of a lead-acid battery or a lithium ion-based battery, and the capacitor module may be composed of a combination of a plurality of unit capacitors.

In FIG. 13, the first switch 130 is illustrated as being positioned between the positive electrode of the capacitor module 120 and the non-grounded end of the starter motor.

In FIG. 13, the booster 140 is connected between the battery module 110 and the capacitor module 120 and boosts the power supplied from the battery module 110 by the second switch 150 to supply the boosted current to the capacitor module 120. When the second switch 150 is turned on or closed, a boost circuit, which is a closed circuit for voltage boosting, is formed between the battery module 110 and the capacitor module 120.

According to this configuration, booster 140 boosts the voltage of the battery module 110 to supply the boosted voltage to the capacitor module 120. The capacitor module 120 can be charged even when the voltage of the battery module 110 is lower than the voltage of the capacitor module 120, and it is possible to supply the voltage for starting the vehicle through boosting even when the battery module 110 and the capacitor module 120 are discharged.

The capacitor module 120 has a lower charging capacity but a higher power density. In other words, since the charging and discharging time of the capacitor module 120 is short and the output is high, even if the vehicle cannot be started with the battery module 110, the capacitor module 120 can be used to drive the starter motor after being charged through boosting.

The control unit 160 determines whether the vehicle can be started, and when it is determined that the vehicle cannot be started, the control unit 160 connects the second switch 150 to configure the booster circuit consisting of the battery module 110, the second switch 150, and the capacitor module 120.

Here, the capacitor module 120 can be replaced with a secondary battery module composed of secondary cells, and it will be apparent that the circuit of FIG. 13 can be applied to eco-friendly vehicles such as electric vehicles instead of internal combustion engine vehicles having a starter motor.

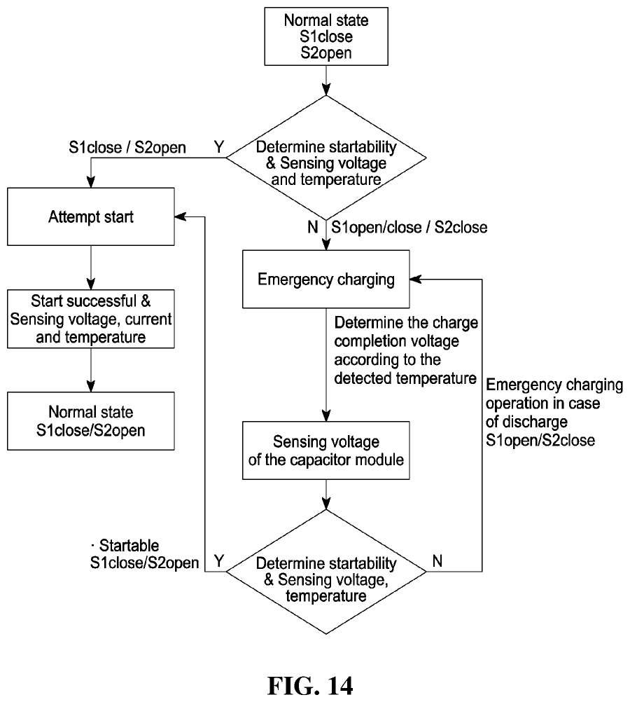

FIG. 14 is a flowchart of a passive process of a vehicle emergency starting device according to a third embodiment of the present invention.

The passive process will be described with reference to FIG. 14.

First, the vehicle emergency starting device closes the first switch 130 and opens the second switch 150 in a normal state so that both the battery module 170 and the capacitor module 120 (or the secondary battery module) are connected to the electrical load, such as starter motor of the vehicle. At this time, the control unit 160 detects the voltage and temperature of the capacitor module 120 (or secondary battery module) and the battery module 110 to determine whether it is possible to start or whether emergency charging is necessary.

If it is determined that the vehicle can be started and then the vehicle is started, the control unit 160 detects voltage, current, temperature, etc., even after the vehicle is started successfully, to check if there is an abnormal operation in the battery module 110 and the capacitor module 120 (or Secondary battery module).

On the other hand, if it is determined that starting the vehicle is impossible, control unit 160 opens the normally closed first switch 130 and closes the second switch 150 (i.e., S1 open, S2 close). According to this configuration, the power of the capacitor module 120 (or the secondary battery module) is blocked from flowing to the dark current of the vehicle during emergency charging through boosting, thereby reducing the loss of the secured starting power and enabling the fastest possible startup of the vehicle.

In addition, since the battery module is connected to the vehicle during the voltage is boosted, a minimum amount of current flows to the vehicle, thereby preventing the vehicle's electrical components from reset.

In some circumstances, the boost circuit may be formed by closing the second switch 150 while the first switch 130 is closed.

Subsequently, control unit 160 detects the voltage of the capacitor module 120 (or the secondary battery module) to determine whether the vehicle can be started or whether emergency charging is completed. Since the voltage required for charging may vary depending on the temperature, it is preferable to determine the charging completion voltage by sensing the temperature.

When the control unit 160 determines that the emergency charging is completed, control unit 160 closes the first switch 130 and opens the second switch 150, to maintain a state where the vehicle can be started. At this time, an effect of charging the discharged battery module 170 occurs while waiting for starting of the vehicle in a state in which the capacitor module 120 (or secondary battery module) is charged.

In other words, when the first switch 130 is closed and the second switch 150 is opened after emergency charging, the vehicle is waiting to start. In this state, a passive process allows the connection of the second switch 150 only when there is a user's input, such as an input by a physical button or an activation of a dedicated mobile application.

In the passive process, the control unit 160 warns the user through a warning lamp or a dedicated mobile application when the engine cannot be started and charges the capacitor module 120 (or the secondary battery module) via the booster 140 when there is a user's command.

According to this configuration, a re-boost process can be manually performed when re-discharge occurs due to long-term neglect after securing starting power.

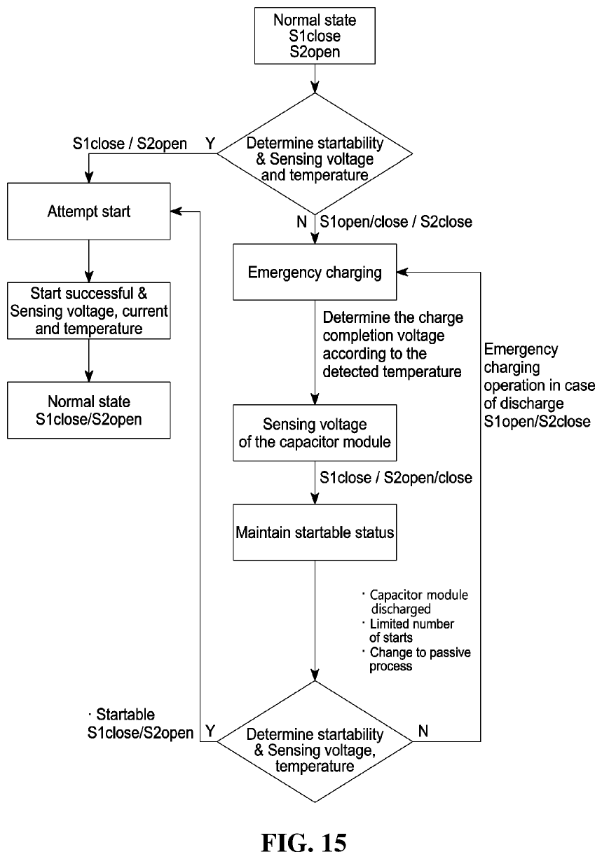

FIG. 15 is a flowchart of an active process of a vehicle emergency starting device according to a third embodiment of the present invention.

An active process will be described with reference to FIG. 15. In the active process, the voltage of the capacitor module 120 (or secondary battery module) is detected by the control unit 160 and, through an automatic boosting (or charging) process, the voltage of the capacitor module (or secondary battery module) is maintained to be always available for starting the vehicle.

First, the vehicle emergency starting device closes the first switch 130 and opens the second switch 150 in a normal state so that both the battery module 110 and the capacitor module 120 (or secondary battery module) are connected to the electric load, such as the starter motor of the vehicle (i.e., S1 close, S2 open). At this time, the control unit 160 detects the voltage and temperature of the capacitor 120 (or secondary battery module) module and the battery module 110 to determine whether it is possible to start or whether emergency charging is necessary.

If it is determined that the vehicle can be started and then the vehicle is started, the control unit 160 detects voltage, current, temperature, etc., even after the vehicle starts successfully, and check the operating state of the battery module 110 and the capacitor module 120 (or secondary battery module).

On the other hand, if it is determined that starting the vehicle is impossible, control unit 160 opens the normally closed first switch 130 and closes the second switch 150 (i.e., S1 open, S2 close). According to this configuration, the power of the capacitor module 120 (or the secondary battery module) is blocked from flowing to the dark current of the vehicle during emergency charging and driving, thereby reducing the loss of the secured starting power and allowing the fastest possible startup.

In addition, since the battery module is connected to the vehicle during the voltage is boosted, a certain amount of current flows to the vehicle, thereby preventing the vehicle's electrical components from resetting.

In some cases, the boost circuit may be formed by closing the second switch 150 while the first switch 130 is maintained to be closed.

Subsequently, the control unit 160 detects the voltage of the capacitor module 120 (or the secondary battery module) to determine whether the vehicle can be started or emergency charging is completed. Since the startup voltage may vary depending on the temperature, it is preferable to determine the charge completion voltage by sensing the temperature.

When the control unit 160 determines that the emergency charging is completed, the control unit 160 closes the first switch 130 and opens the third switch 150, to maintain a state where the vehicle can be started.

At this time, an effect of charging the discharged battery module 170 occurs while waiting for starting of the vehicle while maintaining the capacitor module 120 (or secondary battery module) to be charged.

Even while maintaining this state, the control unit 160 detects the voltage and temperature of the capacitor module 120 (or secondary battery module) to determine whether it is possible to start the vehicle. If it is determined that the capacitor module 120 (or secondary battery module) is discharged and that the startup is impossible, the control unit 160 opens the first switch 130 and closes the second switch 150 without the user's intervention to charge the capacitor module 120 (or the secondary battery module) through the boost process again (i.e., S1 open, S2 close).

In other words, when the first switch 130 is closed and the second switch 150 is opened after emergency charging, the charging is completed and the vehicle is in a standby state. When the first switch 130 and the second switch 150 are closed, the capacitor module 120 is maintained in a fully charged state through a re-boost process, even if a voltage drop occurs in the capacitor module 120 (or the secondary battery module) while waiting for the startup.

Here, the control unit 160 is configured to limit emergency charging through the automatic connection of the second switch 150 to prevent complete discharge of the battery module 110 when the voltage of the battery module 110 is equal to or less than a predetermined minimum value for starting the vehicle by boosting or the number of boosting and re-boosting has exceeded a predetermined reference value. When the automatic connection of the second switch 150 is interrupted in this way, the control unit 160 may enter into a passive process where the second switch 150 is connected only when there is a user's input.

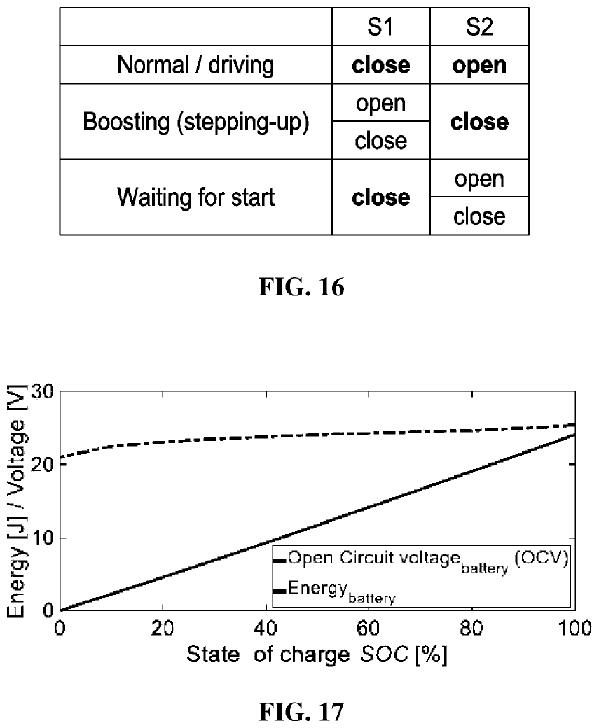

FIG. 16 is a table summarizing the functions of switches in the vehicle emergency starting device according to the third embodiment of the present invention.

Basically, the battery module 170 and the capacitor module 120 are maintained at an equal electric potential by closing the first switch 130 and opening the second switch 150 during normal state (i.e., when the vehicle is parked or when the vehicle is driven). In addition, during boosting, the second switch 150 should be closed to drive the boosting circuit, and after boosting is completed and starting becomes possible, the second switch 130 should be closed to prepare for startup through the capacitor module 120.

When the first switch (S1) is opened during voltage boosting, the current consumed by the dark current of the vehicle (or load) can be limited, and when the 2nd switch (S2) is closed during startup standby, the booster circuit continues to operate and the voltage drop of the capacitor module 120 can be prevented.

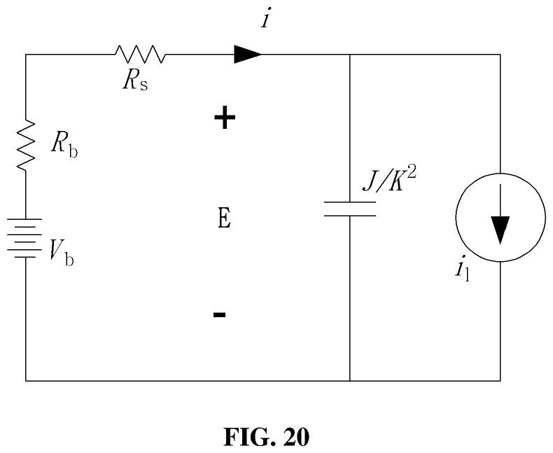

FIG. 20 is a circuit diagram of a starting system for a general internal combustion engine.

Referring to FIG. 20, the definition of the power supplied to the capacitor module, the battery module, and the starter motor is given by a formula

$$\frac{J}{{K}^{2}} \frac{dE}{dt} = i - {i}_{L} ( E ) .$$

The relationship between the battery module voltage (Vb), terminal voltage (E), and resistance (Rb+Rs) voltage can be represented by a formula V_{b}=(R_{b}+Rₛ)i+E. Here, Vb is the battery module voltage, Rb is the internal resistance of the battery, Rs is the rotor resistance of the starter motor, and E is the terminal voltage.

The starting function is a function of the terminal voltage and may be given by an equation Eₛₛ=V_{b}−i_{L}(Eₛₛ)(R_{b}+Rₛ), where Ess is the terminal voltage in the steady state and iL is the starting current. The definition of the rotational speed required to start the starter motor is as follows E=E_{c}=kw_{c}, where Ec is the voltage for starting, k is the proportional constant, and we is the angular velocity for starting.

To start the engine, the terminal voltage in the steady state must be greater than the value of Ec, which can be expressed by a formula V_{b}−i_{L}(Eₛₛ)(R_{b}+Rₛ)>E_{c}. The starting is possible only when the battery's internal resistance is lower than Rbc, which can be expressed as a formula

$${R}_{b} < {R}_{bc} = \frac{{V}_{b} - {E}_{c}}{{i}_{L} ( {E}_{ss} )} - {R}_{s} ,$$

where Rb is the internal resistance of a battery when the starter motor rotates at an angular speed for the startup.

In other words, when attempting to start, the battery's internal resistance must be smaller than the set value (Rbc) to start successfully, and if Rb is greater than Rbc, it is judged as a battery that cannot start the vehicle. Accordingly, it can be confirmed that even a battery without starting capability can store sufficient residual energy for starting the engine while the voltage is insufficient.

In the above, unless otherwise specified, the flow of the active process and the passive process of each circuit, the function of the switches in the active process and the passive process, the relationship between the SOC voltage and the terminal voltage, and the equivalent circuit of the starting system should be understood as equivalent in all embodiments.

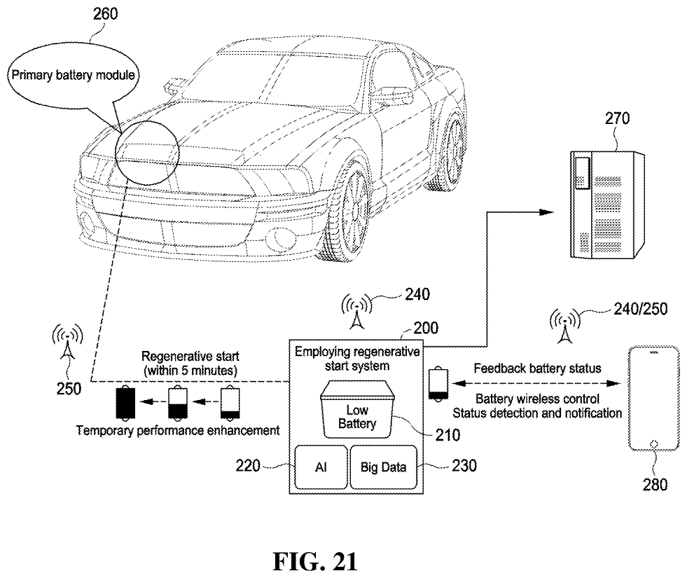

FIG. 21 is a conceptual diagram of a vehicle emergency starting system using artificial intelligence and big data applied to an internal combustion engine vehicle according to an embodiment of the present invention.

In the case of a general vehicle driven by an engine, a 12V or 24V lead-acid battery is used to apply power to the starter motor. Therefore, the switching operation may be performed according to the table of FIG. 11 by using the existing lead-acid battery attached to the vehicle as the primary battery module 170, or the switching operation may be performed according to the table of FIG. 12 by removing the lead-acid battery attached to the vehicle and installing a vehicle emergency starting device embedding a primary battery module 170.

In FIG. 21, the emergency starting device is indicated as a regenerative starting system 200. The regenerative starting system has a structure including a primary battery module 260, a capacitor module (or a secondary battery module), a switch, a control unit (including a booster), and the like.

The vehicle emergency starting device used in the regenerative starting system of FIG. 21 includes a big data DB 230 storing vast amounts of data related to the vehicle starting and an artificial intelligence (AI) module 220 that selects the optimal emergency charging algorithm through learning using big data. Furthermore, it includes a short-distance communication module 250 for communicating with the electric parts inside the vehicle and the user's portable terminal 280 and a long-distance communication module 240 for performing long-distance communication with the remote server 270.

The big data DB 230 includes the battery's internal information (battery type, SOC, SOH (State Of Health), internal resistance, etc.) and external information (temperature, humidity, season, date and time, etc.

In general, the battery capacity is sensitive to temperature. The lower the temperature, the lower the battery performance and the higher the energy required for starting. In addition, the energy required for starting varies according to SOH and SOC. The energy required for starting also varies depending on the vehicle's energy source (gasoline, diesel, electricity, hydrogen, etc.) and the size of the vehicle (engine output, high-voltage battery specification in the case of an electric vehicle, etc.).

Therefore, the above various information is collected in large quantities, configured as big data, and stored in the big data DB 230, while the same data can be stored and/or processed by sending it to the remote server 270 or user terminal 280.

An AI module 220 with an optimization AI algorithm is required to obtain an optimal starting power value under a given situation by utilizing a large amount of data stored in the big data DB 230. The optimization AI algorithm sets a target charging voltage for the capacitor module or secondary battery module and sets a route that can complete emergency charging in the possible minimum time by appropriately applying stepwise voltage increase and decrease and maintains the optimal battery condition so that the battery can be started with the learned power value by applying an active process.

In addition, there is provided a short-distance communication module 250, such as Bluetooth for communication with electric components inside the vehicle or a user's portable terminal 280 and a long-distance communication module 240, such as LTE for long-distance communication with the remote server 270.

Considering the situation of emergency charging due to power shortage, a communication method capable of minimizing power consumption during operation is required. To this end, Bluetooth and LTE modules are installed simultaneously, and appropriate communication technology is applied for each situation. In a normal situation, an LTE module capable of long-distance data transmission and having relatively high power consumption may operate, while the Bluetooth module consuming relatively low power may be turned on or off. However, if the battery is discharged to a voltage below a certain level, the LTE module is turned off, and only the Bluetooth module is turned on.

The LTE communication module 240 is used to transmit data in the big data DB 230 to the remote server 270, and LTE communication is also used for transmitting and receiving the same data between the remote server 270 and the user terminal 280. Furthermore, vehicle location information, fuel economy information, vehicle operation information, vehicle operation status, battery information, various temperature information, etc., are received from OBD2 information from the vehicle, and vehicle status and vehicle failure information can be transmitted to the remote server 270 via LTE communication. The emergency starting device may be remotely controlled through the remote server 270 using a dedicated mobile application installed in the user terminal 280.

On the other hand, when the battery is discharged to a voltage below a certain level, vehicle and battery information is sent to the user terminal 280 using the low-energy Bluetooth module 250 instead of the LTE communication module 240, and the user terminal 280 transmits the same information to the remote server using the LTE communication module 240. The power control required for starting the battery is performed through Bluetooth communication with the user terminal 280.

In other words, the vehicle emergency starting device operates by receiving a user's control command through LTE communication between the vehicle emergency starting device, the remote server, and the user terminal at normal times and operates by receiving a user's control command through direct Bluetooth communication with the vehicle emergency starting device and the user terminal during an emergency starting of the vehicle.

Other types of short-distance wireless communication that can be used other than the above Bluetooth may include RFID, BTE, Wi-Fi, BLE, Zigbee, and Z-Wave, and long-distance wireless communication means may include Wi-Fi, HaLow, 3G˜5G, LTE, and LTE-M, EC-GSM, NB-IoT, MIOTY, LoRa, Sigfox, satellite communication, etc.

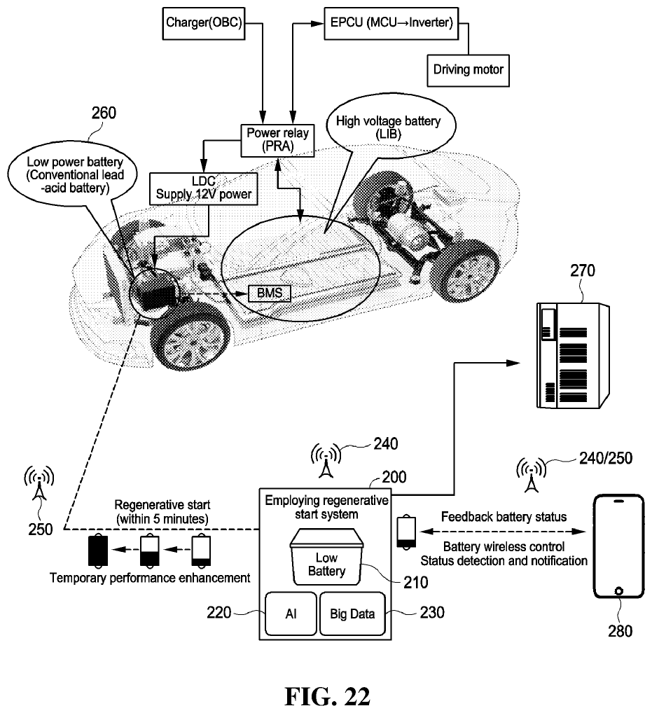

FIG. 22 is a conceptual diagram of a vehicle emergency starting system using artificial intelligence and big data applied to an eco-friendly vehicle according to an embodiment of the present invention.

In FIG. 22, the emergency starting device is indicated as the regenerative starting system 200, and the regenerative starting system has a structure including a low voltage battery 260, a secondary battery module, a switch, a control unit (including a booster), and the like.

The vehicle emergency starting device used in the regenerative starting system of FIG. 22 includes a big data DB 230 storing vast amounts of data related to the vehicle starting and an artificial intelligence (AI) module 220 that selects the optimal emergency charging algorithm through learning using big data. Furthermore, it includes a short-distance communication module 250 for communicating with the electric parts inside the vehicle and the user's portable terminal 280 and a long-distance communication module 240 for performing long-distance communication with the remote server 270.

Here, the specific operation of the vehicle emergency starting system of FIG. 22 is almost the same as that of FIG. 21, so a detailed description will be omitted.

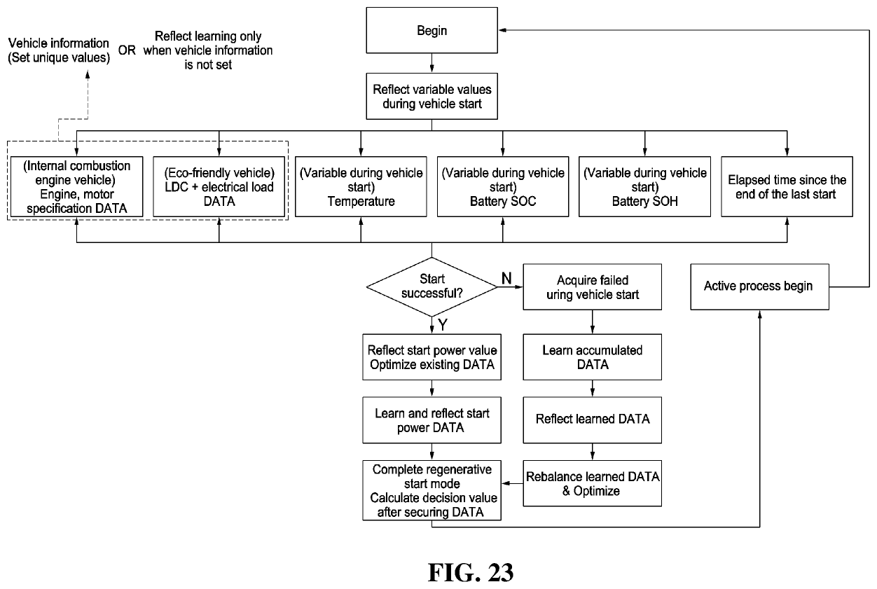

FIG. 23 is an active process flow diagram of a vehicle emergency starting system using artificial intelligence according to an embodiment of the present invention.

The AI module runs an optimization AI algorithm to find the optimal startup power value. FIG. 23 shows a configuration of an active process performed in the emergency starting device according to an exemplary AI algorithm.

First, when the vehicle begins to start, the AI module reflects various variable values for starting to calculate the optimal starting power value. In the case of an internal combustion engine vehicle, they include data on the engine, starter motor specifications, vehicle driving data, etc., and in the case of an eco-friendly vehicle, they include the LCC and electrical load power data. They also include ambient temperature, the battery's SOC and SOH, and the elapsed time since the end of the final startup as variable values for the startup. It is preferable to apply the unique values when vehicle information is set the unique values and reflect learning results only when it is not set as the unique values.

If the emergency startup is successful, the existing data is optimized by reflecting the startup power value, the startup power data is learned and reflected in the big data, the startup power value is calculated through the obtained data, and the regenerative startup mode is completed.

If an emergency startup fails, the failed power value is learned as accumulated data, reflected in big data, and the learning data is readjusted and optimized to secure data, and then the startup power value is calculated, and the regenerative start mode is completed.

When the regenerative starting mode is completed, an active process starts. When it is determined that the discharge has occurred to the extent that emergency starting is impossible, an active process of restarting the regenerative starting mode proceeds.

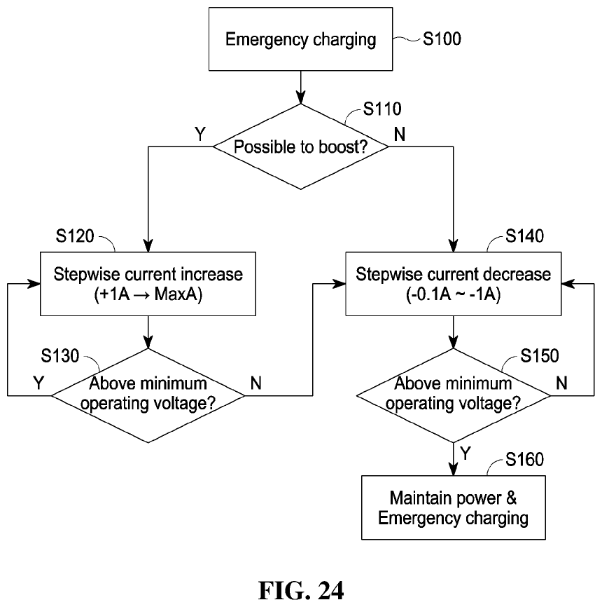

FIG. 24 is a flow chart of a step-by-step current increase/decrease process in a vehicle emergency starting device according to an embodiment of the present invention.

FIG. 24 details an emergency charging step in the process shown in FIGS. 11 and/or 15.

First, when it is determined that emergency charging is necessary and emergency charging starts by closing the switch for driving the booster circuit (S100), the control unit checks whether a boost operation is possible, that is, whether the boost converter or the DC-DC converter operates (S110).

Determination of whether or not boosting is possible is made in a very short time (a time value between 0.1 and 2 seconds can be set). When it is determined that voltage boosting is possible, the current is increased step by step (S120), and when it is determined that voltage boosting is impossible, the current is reduced step by step (S140).

Determination of whether boosting is possible is to check whether the operation of the DC-DC converter is abnormal and/or to determine whether the voltage of the battery module is at a level at which emergency startup through boosting is impossible, that is, whether it is higher than or lower than the minimum operating voltage.

For example, by first applying a current of 1 A (ampere) to drive the DC-DC converter, and if there is no problem, the current is further increased by 1 A (S120), and again the presence or absence of an abnormal operation of the DC-DC converter, that is, the possibility of boosting the voltage is checked in a short time (S130). This process is repeated up to the maximum possible current value.

When the voltage is higher than the minimum operating voltage, which means there is no problem driving the DC-DC converter, the current is increased stepwise (S120). The current is reduced stepwise when the operating voltage is lower than the minimum operating voltage (S140).

The stepwise reduction of the current is to reduce the current by, for example, 1 mA to 100 mA to lower the current value up to 1 A, and accordingly, it is determined in a short time whether the voltage returns to a value equal to or higher than the minimum operating voltage (S150). If the voltage is less than the minimum operating voltage when determining the initial startup before boosting, a current reduction of 1 A or more may be required.

When the voltage of the battery module exceeds the minimum operating voltage by the stepwise current reduction, the current value is fixed to maintain power and emergency charging is performed (S160), and if it is still less than the minimum operating voltage, the stepwise current reduction step is repeated (S140).

Although the present invention has been described in terms of some preferred embodiments, the scope of the present invention should not be limited thereto but should include modifications and improvements of the above embodiments.

1. A vehicle emergency starting device comprising:
a battery group connectable to a starter motor of a vehicle through a first switch;
a capacitor module connectable to the starter motor in parallel with the battery group through a second switch;
a booster connected between the battery group and the capacitor module through a third switch; and
a control unit for controlling the operation of the above switches and the booster,
wherein the control unit controls the booster to boost the power supplied from the battery group to charge the capacitor module.

2. The vehicle emergency starting device of claim 1,
wherein the control unit controls to close the first switch and the second switch and open the third switch at normal state.

3. The vehicle emergency starting device of claim 1,
wherein the control unit determines whether or not the vehicle can be started by the battery group or the capacitor module, and controls to close the third switch when it is determined that the vehicle cannot be started.

4. The vehicle emergency starting device of claim 3,
wherein the control unit controls to open one of the first switch and the second switch when the third switch is closed.

5. The vehicle emergency starting device of claim 3,
wherein the control unit controls to open both the first switch and the second switch when the third switch is closed.

6. The vehicle emergency starting device of claim 1,
wherein the control unit determines whether or not the vehicle can be started by the battery group or the capacitor module, and controls to close the second switch when it is determined that the vehicle can be started.

7. The vehicle emergency starting device of claim 6,
wherein the control unit controls to open the third switch when the second switch is closed.

8. The vehicle emergency starting device of claim 3,
wherein the control unit controls to stop the connection of the third switch when the number of connections of the third switch is equal to or more than a preset reference number of times.

9. The vehicle emergency starting device of claim 1,
wherein the control unit determines whether or not the vehicle can be started using terminal voltages of the battery group and the capacitor module connected in parallel with each other and the size of the internal resistance of the battery group.

10. The vehicle emergency starting device of claim 1,
wherein the battery group is composed of a connection between an external battery installed in the vehicle and an internal battery module embedded in the vehicle emergency starting device.
